(19) United States
(12) Patent Application Publication
(10) Pub. No.: US 2017/0340104 A1
(43) Pub. Date: Nov. 30, 2017

(54) LIFTING PLATFORM

(71) Applicant: KELLY INTERNATIONAL CORP., Taipei City (TW)

(72) Inventor: Min-Lon CHUANG, Taipei City (TW)

(73) Assignee: KELLY INTERNATIONAL CORP., Taipei City (TW)

(21) Appl. No.: 15/431,313

(22) Filed: Feb. 13, 2017

(30) Foreign Application Priority Data
May 27, 2016 (TW) 105207853

(51) Int. Cl. A47B 9/16; A47B 21/02; B66F 7/06; B66F 7/08

(52) U.S. Cl. CPC A47B 9/16; B66F 7/085; A47B 21/02; B66F 7/065

(57) ABSTRACT

A lifting platform, includes a movable support frame composed of a first and a second frames being cross pivotally and slidably connect between a bearing platform and a base, at least a positioning connecting rod set between the movable support frame and a portion close to the middle of the bearing platform or the base, and a damping extension element combine with an adjustment element and mounted on the movable support frame between the bearing platform and the base; the damping extension element controlled with extension or locking for adjusting the cross angle of the movable support frame, the adjustment element is provided to adjust the position of the damping extension element to form different supporting force to balance difference of bearing weight of the bearing platform, to achieve the effect of reducing the force required to operate the bearing platform for lifting.

### BACKGROUND OF THE INVENTION

### 1. Field of the Invention

The present invention relates to a platform lifting structure and, more particularly, to a lifting platform with centered support center of gravity and stable bearing capacity, which is provided to easily operate for lifting and stop positioning.

### 2. Description of Related Art

A conventional lifting mechanism for easily operating to adjust the height and position, simple ones, such as a common office pneumatic chair structure, wherein a chair is set on a bracket with wheels through an extension pneumatic device, and the pneumatic device is provided to operate by a control switch to fasten its extension position if locked and release extension force (it is usually not greater than human body weight) outwards if unlocked; if the force is greater than bearing weight, it could be extended continuously, so that the chair may be raised; if the force is smaller than bearing weight, it could be contracted, so that the chair could be adjusted and fixed at different heights to meet the needs of the use of different heights. However, the structure is a mechanism with only one single shaft for supporting, the supporting effect may not be achieved if the bearing area is too large, thus, it could not be applied in lifting table structure. For example, in the existing lifting tables, the pneumatic device applies a fixed amount of pushing force (extension force), the pushing force could not be adjusted timely. Thus, when a user wants to adjust its height, the user needs to force it down hard to lower the height if the bearing weight is smaller, the user needs to lift it up to raise the height if the bearing weight is too large, the inconvenience of use could not be reduced.

A mechanism with a first bracing rod and a second bracing rod cross jointed is provided to set between a table and a base, wherein an upper end of the first bracing rod is engaged with a bottom side of the table, a lower end of the first bracing rod is slidably touched to the base, a lower end of the second bracing rod at the same side is engaged with the base, an upper end of the second bracing rod is slidably touched to the bottom side of the table, and a pneumatic device is further set between the first bracing rod and the second bracing rod. In operation, the first bracing rod and the second bracing rod are provided to be adjusted to different cross angles with supporting by the pneumatic device, so that the table could be fixed at different height according to actual needs. However, in practical application of the structure, since two ends of the first and the second bracing rods are respectively engaged with the same side of the table and the base, force may be concentrated to the ends of the first and the second bracing rods sliding on the bottom side of the table and the base in the process of adjusting the table up and down, so that the table may be easily shaken and the overall stability may be affected.

In view of the above drawbacks of a conventional platform lifting structure, the inventor improved the drawbacks and finally completed the present invention.

### SUMMARY OF THE INVENTION

The object of the present invention is to provide a lifting platform, wherein a movable support frame is set between a pre-set bearing platform and a base, the movable support frame is composed of a first and a second frames with their middle sections being cross and pivoted to each other, a damping extension element provided for being control to extend is set between the first and the second frames. By the property of the damping extension element that an equivalent pushing force (extension force) is released as a supporting force for balancing bearing weight of the bearing platform when the damping extension element is unlocked and stop positioning when it is locked, the required force of operation may be reduced effectively. Also, the first and the second frames are provided to support the bearing platform, so the first and the second frames could form a stable support in the processing of changing the cross angle with the lifting height of the bearing platform, to thereby provide a stable and labor-saving operation mechanism of lifting a bearing platform.

Another object of the present invention is to provide a lifting platform, at least a positioning connecting rod is set on the first frame (or the second frame), and the positioning connecting rod is connected to a portion close to the middle of the bearing platform or the base, so that the movable support frame could always be in a relatively central position in the lifting processing of the bearing platform without letting center of gravity of the bearing platform be shifted, and stress on two sides could be balanced, to ensure the stability and smoothness of the bearing platform lifting operation.

The other object of the present invention is to provide a lifting platform, wherein an adjustment element is set on one end of the damping extension element, the adjustment element is provided to adjust the connected position of the end of the damping extension element, to thereby adjust the angle of the damping extension element for support according to different bearing weight of the bearing platform, so that the fixed pushing force of the damping extension element could form different supporting force (vertical component) for different angle to achieve the effect of balancing bearing weight of the bearing platform flexibly and reducing operating force effectively.

Another object of the present invention is to provide a lifting platform, wherein a stopper element adjustable for position is set on the bearing platform, the stopper element is located on the moving path of the end of the first frame (or the second frame), the stopper element is provided to stop the end of the first frame (or the second frame) from moving to limit the angle between the first and the second frames by adjusting and fixing the stopper element to a predetermined position, so that the bearing platform is limited at the predetermined lifting height, to thereby adjust the stopper element to a limiting position of a height commonly used according to the height commonly used by users. For later use, lifting to the stop position is exactly the height commonly used, and users are no longer required to adjust to the height commonly used repeatedly each time.

To achieve the above objects, technical means of the present invention includes: a base; a bearing platform for bearing objects, which is set above the base and is movable up and down relative to the base; a movable support frame, which is composed of a first and a second frames with their middle sections being cross and pivoted to each other, upper ends of the first and second frames are slidably connected to a bottom side of the bearing platform respectively, and lower ends of the first and second frames are slidably connected to the base respectively, so that the bearing platform driven by the first and the second frames pivoted between the base and the bearing platform is movable up and down relative to the base, wherein, the bearing platform is close to the base when the upper ends of the first and the second frames are relatively away, and the bearing platform is away from the base when the upper ends of the first and the second frames are relatively close, also, at least a positioning connecting rod is set on one of the first and the second frames, the positioning connecting rod is also connected to a middle portion of the base or the bearing platform, so that the movable support frame is provided to pivot in the middle between the base and the bearing platform; a damping extension element, which is set on the movable support frame and is controlled by a control switch for locking or unlocking its extended mode to adjust the cross angle of the movable support frame, wherein, when the damping extension element is locked, the cross angle of the movable support frame is fixed to fix the position of the bearing platform relative to the base, when the damping extension element is unlocked, the cross angle of the movable support frame is provided to be adjusted by extending or compressing it, to thereby adjust the position of the bearing platform relative to the base.

According to the above structure, wherein the damping extension element is a pneumatic cylinder with locking function, which is used to provide pushing force for extension.

According to the above structure, wherein the control switch is connected to the damping extension element through a control cord.

According to the above structure, wherein an adjustment element is set on one end of the damping extension element, the adjustment element is provided to change position of the end of the damping extension element for adjusting a setting angle of the damping extension element, to thereby adjust the pushing force for supporting formed by the damping extension when it is unlocked.

According to the above structure, wherein the adjustment element includes a rotatable threaded rod and a slider screwed on the rotatable threaded rod, and the end of the damping extension element is pivotally combined with the slider, the position of the slider is adjusted when the rotatable threaded rod rotates, so that the setting angle of the damping extension element is adjusted. By using the adjustment element, users could adjust the damping extension element according to bearing weight of the bearing platform. The damping extension element with different tile angles may have different size of supporting force to balance various weight-bearing requirements, to thereby achieve the effect of lifting or pressing without extra effort. It could be adjusted according to different bearing weight. According to the above structure, there are a plurality of positioning connecting rods defined as an upper positioning connecting rod or a lower positioning connecting rod respectively, each of the upper positioning connecting rod is set between an upper section of the first frame or the second frame and the bearing platform, each of the lower positioning connecting rod is set between a lower section of the first frame or the second frame and the base.

According to the above structure, connection position of two ends of the damping extension element may be various: one of them is, one end of the damping extension element is pivotally connected with the first frame or the second frame, and the other end of the damping extension element is pivotally set on the bearing platform or the base; another one is, two ends of the damping extension element are respectively pivotally connected with the first frame and the second frame, one of the two ends is pivotally connected with an upper section of one of the first and the second frames, and the other end is pivotally connected with an lower section of another of the first and the second frames.

According to the above structure, wherein lower guide grooves parallel and symmetrical to each other are respectively set on two sides of the two ends of the base, the bearing platform includes several slide seats parallel and symmetrical to each other on two sides of the two ends of the bottom side of the bearing platform, each of the slide seat includes an upper guide groove extendedly parallel to each other on relative side, a first upper cross rod is set on an upper end of the first frame, two ends of the first upper cross rod are respectively inserted into the upper guide grooves of the two slide seats on a side of the bearing platform, a first lower cross rod is set on a lower end of the first frame, two ends of the first lower cross rod are respectively inserted into two lower guide grooves on a side of the base, a second upper cross rod is set on an upper end of the second frame, two ends of the second upper cross rod are respectively inserted into the upper guide grooves of two slide seats on the other side of the bearing platform, a second lower cross rod is set on a lower end of the second frame, two ends of the second lower cross rod are respectively inserted into the lower guide grooves on the other side of the base respectively.

According to the above structure, wherein one end of the damping extension element is pivotally connected with the first upper cross rod, the other end of the damping extension element is pivotally connected with a lower section of the second frame. Moreover, the adjustment element could be set on the lower section of the second frame, one end of the damping extension element is engaged with the first cross rod, the other end of the damping extension element is pivotally combined with the slider of the adjustment element.

According to the above structure, wherein one end of the damping extension element is pivotally connected with an upper section of the second frame, the other end of the damping extension element is pivotally connected with the first lower cross rod. Moreover, the adjustment element could be set on the upper section of the second frame, one end of the damping extension element is pivotally connected with the first lower cross rod, the other end of the damping extension element is pivotally combined with the slider of the adjustment element.

According to the above structure, wherein a stopper element adjustable for position is set on the bearing platform, the stopper element is located on the moving path of at least one of the first and the second upper cross rod, the stopper element is provided to adjust for limiting slidable range of the first or the second upper cross rod, to thereby limit the angle between the first and the second frames, so that the bearing platform is limited and stopped at the predetermined lifting height.

According to the above structure, wherein the stopper element includes a protruding stopper portion and at least a long hole, the stopper portion is provided to stop the first or the second upper cross rod, the at least a long hole is provided for a positioning element to pass through and screw into the bottom side of the bearing platform, so that the stopper element is adjustably fixed to a predetermined position on the bottom side of the bearing platform.

For more specific understanding, the above objects, utilities and features of the present invention are described as follow according to the accompanying figures:

### BRIEF DESCRIPTION OF THE DRAWINGS

FIG. 1 is an appearance diagram of the first embodiment of the present invention;

FIG. 2 is a structure diagram of the first embodiment of the present invention;

FIG. 3 is a bottom-view diagram of the first embodiment of the present invention;

FIG. 4 is a schematic diagram of operation of the support position of the damping extension element changed by the adjustment element according to the first embodiment of the present invention;

FIG. 5 is a schematic diagram (1) of operation of adjusting height of the bearing platform of the first embodiment of the present invention;

FIG. 6 is a schematic diagram (2) of operation of adjusting height of the bearing platform of the first embodiment of the present invention;

FIG. 7 is a schematic diagram (3) of operation of adjusting height of the bearing platform of the first embodiment of the present invention; and

FIG. 8 is a side-view diagram of the second embodiment of the present invention.

### DETAILED DESCRIPTION OF THE INVENTION

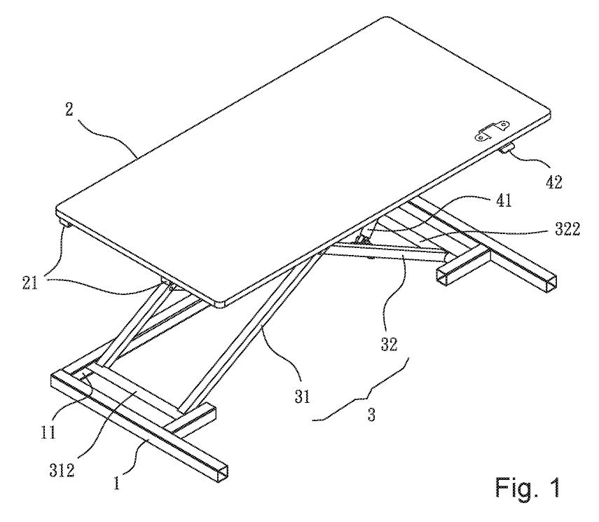

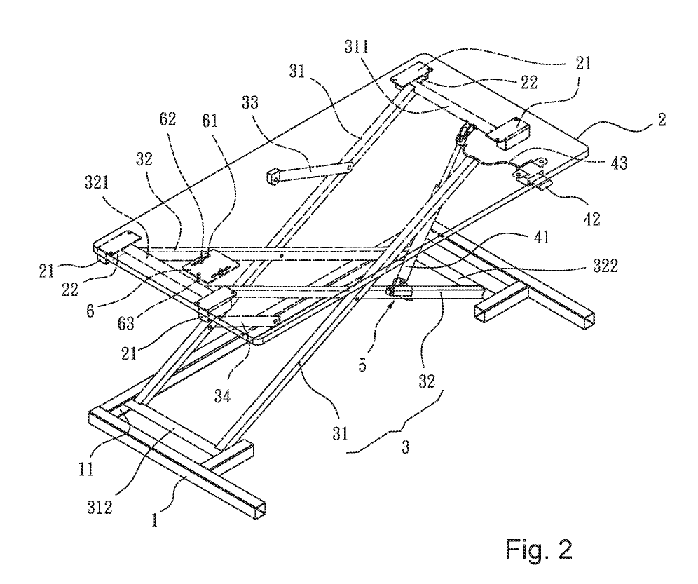

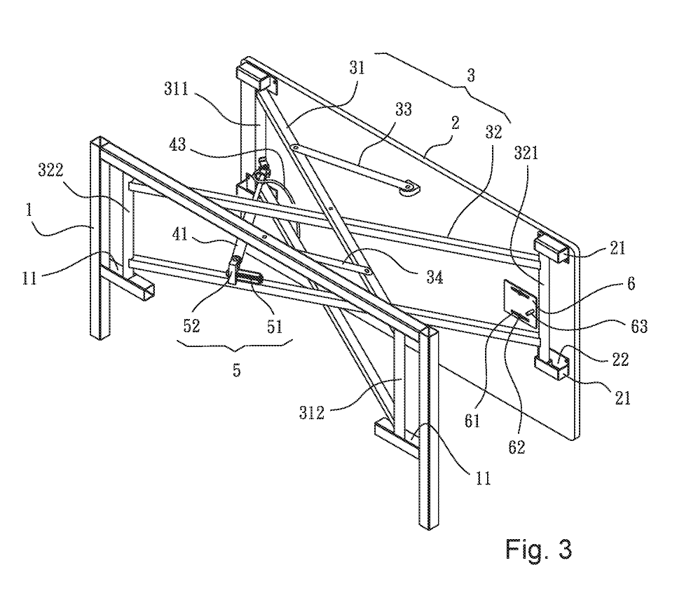

Please refer to FIG. 1 to FIG. 3, the first embodiment of the present invention includes: a base 1, a bearing platform 2, a movable support frame 3 and a damping mechanism 4, wherein lower guide grooves 11 parallel and symmetrical to each other are set on two sides of two ends of the base 1.

A top side of the bearing platform 2 is a surface for supporting objects, slide seats 21 parallel and symmetrical to each other are set on two sides of two ends of a bottom side of the bearing platform 2, each of the slide seat 21 includes an upper guide groove 22 extendedly parallel to each other on relative side.

The movable support frame 3 is composed of a first frame and a second frame with their middle sections being cross and pivoted to each other. In practice, there are various compositions of the first frame and the second frame, such as I-shaped bracket composed of a bracing rod and two cross rods, or a H-shaped bracket composed of two bracing rods and a cross rod, or the rectangular bracket composed of two bracing rods and two cross rods as shown in the embodiment. Each first bracing rod 31 of the first frame and each second bracing rod 32 of the second frame are pivoted to each other with their middle sections cross, a first upper cross rod 311 set crosswise is connected to an upper end of each first bracing rod 31, two ends of the first upper cross rod 311 are inserted into the upper guide grooves 22 of the two slide seats 21 on a side of the bearing platform 2, a first lower cross rod 312 set crosswise is connected to a lower end of each first bracing rod 31, two ends of the first lower cross rod 312 are inserted into the lower guide grooves 11 on a side of the base 1, a second upper cross rod 321 set crosswise is connected to an upper end of each second bracing rod 32, two ends of the second upper cross rod 321 are inserted into the upper guide grooves 22 of the slide seats 21 on the other side of the bearing platform 2, a second lower cross rod 322 set crosswise is connected to an lower end of each second bracing rod 32, two ends of the second lower cross rod 322 are inserted into the lower guide grooves 11 on the other side of the base 1.

In order to fix the sliding position of the movable support frame between the base 1 and the bearing platform 2, at least a positioning connecting rod is set on the first bracing rod 31 or the second bracing rod 32 (namely the first frame or the second frame), the positioning connecting rod is also engaged with the base 1 and the bearing platform 2, so that the movable support frame 3 could be moved in a predetermined motion area. In the embodiment, an upper positioning connecting rod 33 and a lower positioning connecting rod 34 are respectively connected to the first bracing rod 31 (or the second bracing rod 32). The upper positioning connecting rod 33 is provided to connect to the middle part on the bottom side of the bearing platform 2, and the lower positioning connecting rod 34 is provided to connect to the middle part of the base 1, so that the movable support frame 3 could move in a central position, to let the support center of gravity of the bearing platform 2 keep centered and stable.

The damping mechanism 4 is composed of a damping extension element 41 (which could be a pneumatic cylinder with locking function) and a control switch 42, the damping extension element 41 is set on the movable support frame, its two ends could have various assembly position, in practice, they could be pivotally connected with an upper portion and an lower portion of the same side of the movable support frame (same on left side or same on right side), the upper portion could be the upper section of the first bracing rod 31, the upper section of the second bracing rod 32, the first upper cross rod 311, the second upper cross rod 321 or the bottom side of the bearing platform 2, the lower portion could be the lower section of the first bracing rod 31, the lower section of the second bracing rod 32, the first lower cross rod 312, the second lower cross rod 322 or the base 1. In the embodiment, the damping extension element 41 is respectively set between the first bracing rod 31 and the second bracing rod 32 (one end of the damping extension element 41 is connected to the first upper cross rod 311, the other end of the damping extension element 41 is connected to a side of the second bracing rod 32 close to the base 1), the damping extension element 41 is connected to the control switch 42 through a control cord 43, the control switch 42 could be set on a side of the bearing platform 2; when the control switch 42 is pressed, the damping extension element 41 could be controlled to extend or compress by external force; when the control switch 42 is released, the damping extension element 41 is locked without being extended.

In a practical embodiment, the damping extension element 41 (pneumatic cylinder) generates a considerable acting force (outward-pushing force) when it is unlocked, vertical component of the acting force could be provided as a supporting force for balancing bearing weight of the bearing platform 2, so that users may easily push the bearing platform 2 up or down without applying force for supporting the bearing weight of the bearing platform 2 when unlocking for operation. Moreover, an adjustment element 5 is set on one end of the damping extension element 41, the adjustment element 5 includes a rotatable threaded rod 51, which is set on the second bracing rod 32 (or the first bracing rod 31), and a slider 52 screwed on the rotatable threaded rod 51, and the end of the damping extension element 41 is pivotally combined with the slider 52, the rotatable threaded rod 51 is provided to adjust the position of the slider 52, to drive the damping extension element 41 and adjust the supporting angle of the damping extension element 41, to thereby adjust vertical component of generated force, so that users may adjust the amount of supporting force generated by the damping extension element 41 for different weight-bearing requirements.

In a practical embodiment, a stopper element 6 is set on a side of the bottom side of the bearing platform close to the second upper cross rod 321 (or the first upper cross rod 311), the stopper element 6 is approximately located on the position of the moving path of the second upper cross rod 321 (or the first upper cross rod 311), a protruding stopper portion 63 and two long holes 61 are set on it, two positioning pieces 62 (could be bolts) are provided to pass through the long holes 61 to adjustably fix the stopper element 6 on the bottom side of the bearing platform 2, so that the stopper portion 63 could form a stop in the moving path of the second upper cross rod 321 (or the first upper cross rod 311), to thereby limit the angle between the first bracing rod 31 and the second bracing rod 32, to let the bearing platform 2 be limited and stopped at the predetermined lifting height. Thus, the stopper element 6 is provided to memorize an accustomed height for users, the stopper element 6 may only be adjusted to a predetermined position (such as the locking position used for last time), and the lifting operation could be stopped at the limited height afterward without adjusting repeatedly, so the operation convenience may be improved.

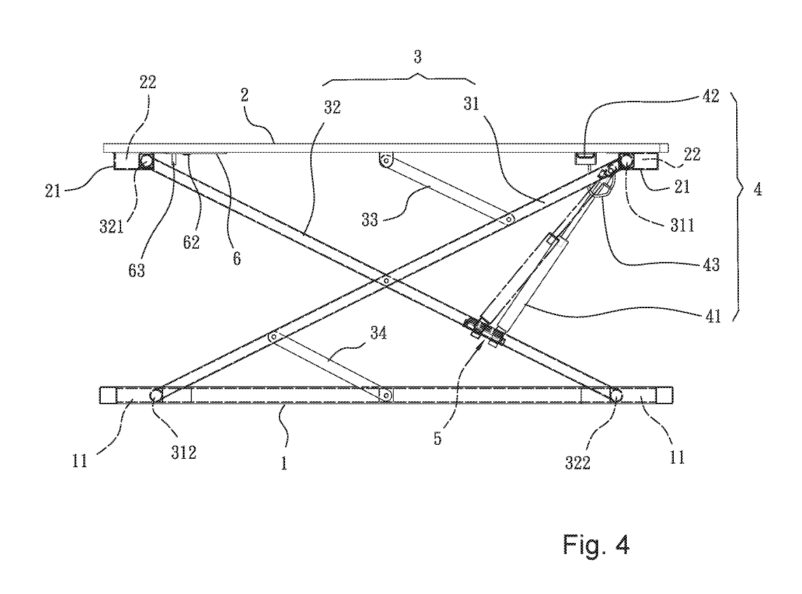

Please refer to FIG. 4 to FIG. 7, in practical application of the first embodiment of the present invention, the position of the slider 52 is adjusted when the rotatable threaded rod 51 rotates, the damping extension element 41 is driven to adjust the position supported on the second bracing rod 32 (or the first bracing rod 31) to form different supporting force for the bearing platform 2 (as shown in FIG. 4), to let the bearing platform 2 and bearing weight achieve balance with the supporting force of the damping extension element 4 for various bearing weight on the bearing platform 2, to reduce the force required to operate for lifting.

In operation, when the control switch 42 is pressed, the damping extension element 41 could be controlled to be unlocked, at this time, the supporting force of the damping extension element 41 may appropriately cancelled most weight of the bearing platform 2 and bearing weight, the bearing platform 2 could be pulled (or pushed) by smaller operating force to drive the movable support frame 3, so that the angle between the first and the second bracing rods 31, 32 may be adjusted, the first and the second upper cross rod 311, 321 are provided to slide on the upper guide grooves 22, the first and the second lower cross rods 312, 322 are provided to slide on the lower guide grooves 11, so that the movable support frame 3 could be fully provided for lifting operation of the bearing platform 2; after the height adjustment of the bearing platform 2 is completed, the control switch 42 would be released, the damping extension element 41 is locked, so as to keep the bearing platform 2 at a fixed height and form support.

In the above structure, in the lifting process of the bearing platform 2, since the first and the second bracing rods 31, 32 of the movable support frame 3 is provided to slide on two sides of the bearing platform 2 simultaneously, the resulting stress generated on two sides of the bearing platform 2 could keep balanced, the first bracing rod 31 (or the second bracing rod 32) is respectively connected to the central part of the bottom side of the bearing platform and the central part of the base respectively by the connecting rods 33, 34 on upper and lower sides, thus the stress on two sides are dispersed to ensure the stability of motion of the bearing platform 2.

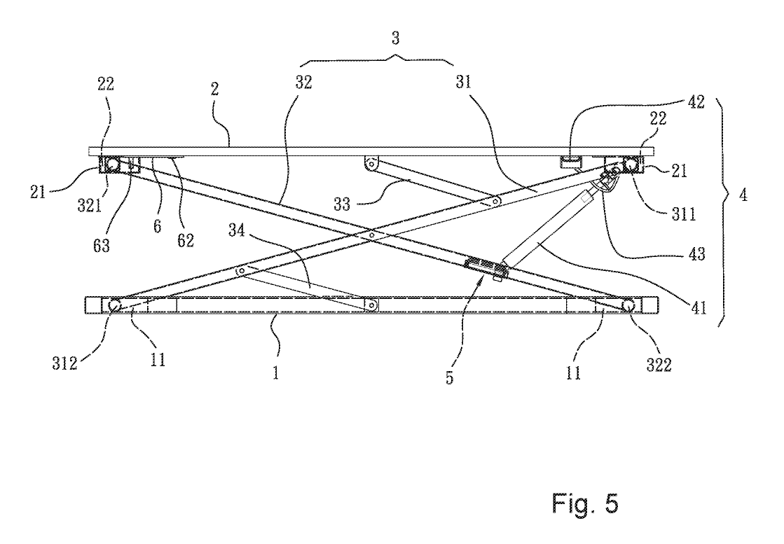

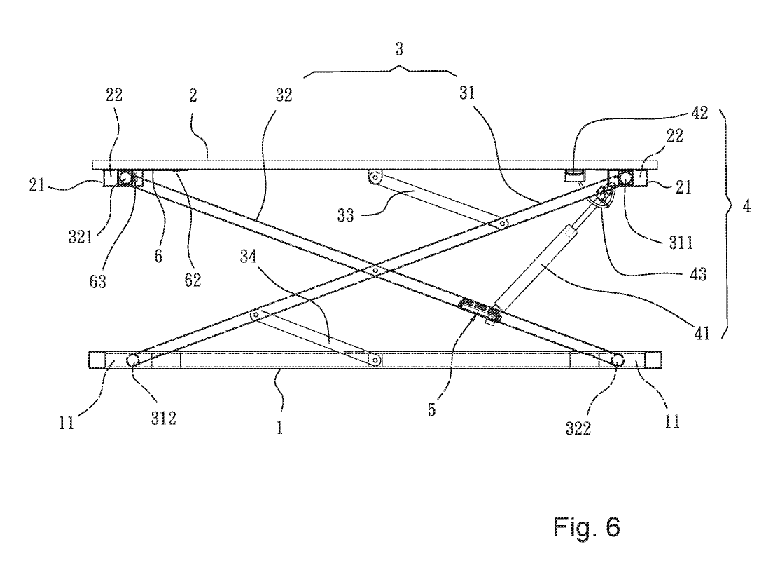

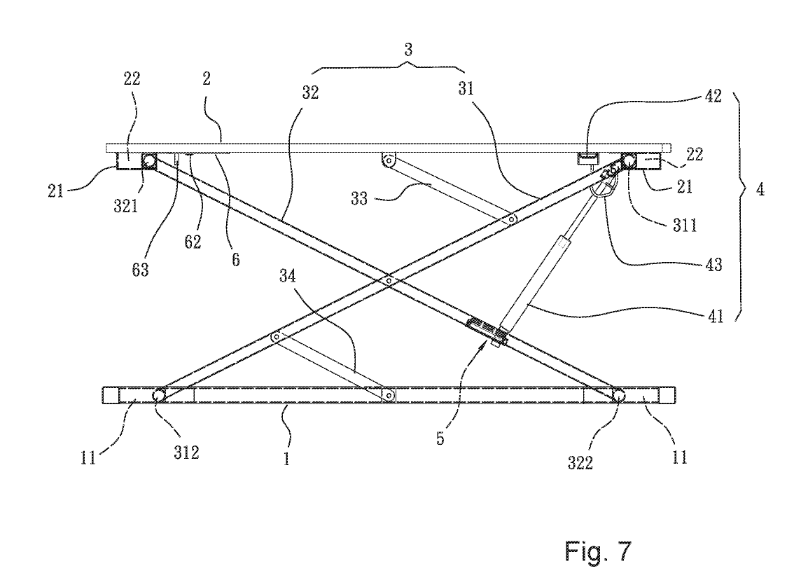

In practical application, the above structure of the present invention could set under a desk or work platform, the bearing platform 2 could also be provided as a desk (or work platform), so that office workers (or workers) can adjust the height of desk (or platform) according to standing or sitting needs, to avoid sitting for a long time that have negative impacts on health. However, the height of each person is different, the lifting height is also different, for improvement of the operation convenience, when a user changes to stand and lift the bearing platform 2 to an accustomed height, the stopper element 6 could be adjusted to let the stopper portion 63 touch the second upper cross rod 321 (as shown in FIG. 6) for limiting or memorizing the accustomed height; when the user changes to sit and press the bearing platform 2, the stopper element 6 still keeps in the predetermined position (as shown in FIG. 5); when the user lifts it for using again, the bearing platform 2 is provided to change the height, the second upper cross rod 321 driven by the first and the second bracing rods 31, 32 is moved, the stopper portion 63 is provided to stop the second upper cross rod 321 moving for limiting the angle between the first and the second bracing rods 31, 32, so that the bearing platform 2 is limited to stop at the predetermined height (as shown in FIG. 6), to thereby provide for users to easily and quickly adjust the bearing platform 2 to an accustomed height without adjusting to the original position repeatedly; certainly, if the stopper portion 63 of the stopper element 4 is moved out of the moving path of the second upper cross rod 321 (or the first upper cross rod 311) (shown in FIG. 7), the bearing platform 2 could be lifted to the highest position unrestrictedly.

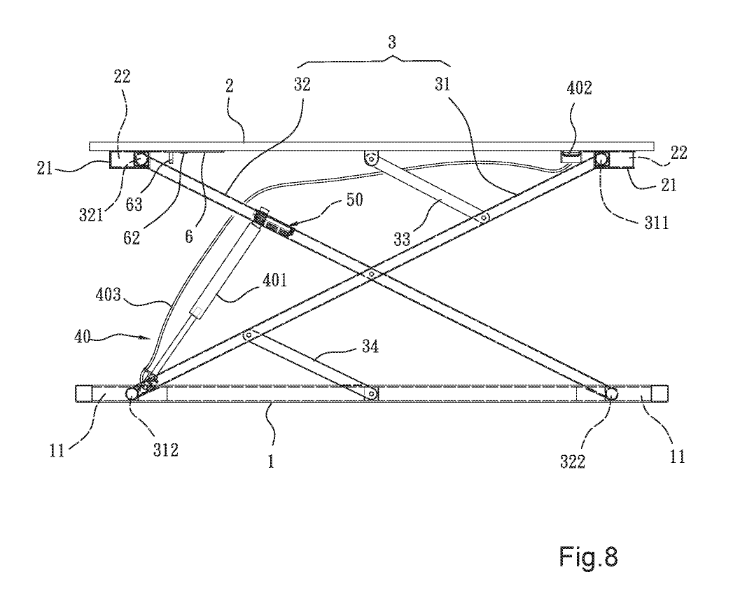

Please refer to FIG. 8, the structure of the second embodiment of the present invention includes: a damping mechanism 40, an adjustment element 50 and the base 1, the bearing platform 2, the movable support frame 3 and the stopper element 6 the same as the first embodiment, wherein the adjustment element 50 has the same structure as the adjustment element 5, the difference is only that: the adjustment element 50 is set on a side of the second bracing rod 32 close to the bearing platform 2, the damping mechanism 40 is composed of a damping extension element 401 and a control switch 402 connected to the damping extension element 401 by a control cord 403, one end of the damping extension element 401 is connected to the adjustment element 50, the other end of the damping extension element 401 is connected to the second lower cross rod 322, so that the damping mechanism 40 could be set between the first bracing rod 31 and the second bracing rod 32 by another different way; and the operation method of the damping mechanism 40 and the adjustment element 50, the driving relationship of the base 1, the bearing platform 2, the movable support frame 3 and the stopper element 6 is the same as the first embodiment and is thus not described in detail here.

Above all, the lifting platform of the present invention could achieve the effect of stable lifting and positioning and adjusting supporting force for different effort needs, which is really a creation with novelty and progress, and the inventor apply for patent according to the law; however, the above description is only the preferred embodiments of the present invention, any variation, modification, change or equivalent replacement extended from technical means and scopes of the present invention shall be included within the scope of the patent application of the present invention.

What is claimed is:

1. A lifting platform, which at least includes:
a base;
a bearing platform, which is set above the base, is movable up and down relative to the base;
a movable support frame, which is composed of a first and a second frames with their middle sections being cross and pivoted to each other, upper ends of the first and second frames are slidably connected to a bottom side of the bearing platform respectively, and lower ends of the first and second frames are slidably connected to the base respectively, so that the bearing platform driven by the first and the second frames pivoted between the base and the bearing platform is movable up and down relative to the base, wherein, the bearing platform is close to the base when the upper ends of the first and the second frames are relatively away, and the bearing platform is away from the base when the upper ends of the first and the second frames are relatively close, also, at least a positioning connecting rod is set on one of the first and the second frames, the positioning connecting rod is also connected to a middle portion of the base or the bearing platform, so that the movable support frame is provided to pivot in the middle portion between the base and the bearing platform;
a damping extension element, which is set on the movable support frame and is controlled by a control switch for locking or unlocking its extended mode to adjust the cross angle of the movable support frame, wherein, when the damping extension element is locked, the cross angle of the movable support frame is fixed to fix the position of the bearing platform relative to the base, when the damping extension element is unlocked, the cross angle of the movable support frame is provided to be adjusted by extending or compressing it, to thereby adjust the position of the bearing platform relative to the base.

2. The lifting platform as claimed in claim 1, wherein the base includes several lower guide grooves parallel and symmetrical to each other, and the lower guide grooves are respectively set on two sides of two ends of the base; the bearing platform includes several slide seats parallel and symmetrical to each other, and the slide seats are set on two sides of two ends of the bottom side of the bearing platform, each of the slide seat includes an upper guide groove extendedly parallel to each other on relative side; a first upper cross rod is set on the upper end of the first frame, two ends of the first upper cross rod are respectively inserted into the upper guide grooves of the two slide seats on a side of the bearing platform, a first lower cross rod is set on the lower end of the first frame, two ends of the first lower cross rod are respectively inserted into two lower guide grooves on a side of the base, a second upper cross rod is set on the upper end of the second frame, two ends of the second upper cross rod are respectively inserted into the upper guide grooves of two slide seats on the other side of the bearing platform, a second lower cross rod is set on the lower end of the second frame, two ends of the second lower cross rod are respectively inserted into the lower guide grooves on the other side of the base respectively.

3. The lifting platform as claimed in claim 2, wherein one end of the damping extension element is pivotally connected with the first upper cross rod, the other end of the damping extension element is pivotally connected with a lower section of the second frame.

4. The lifting platform as claimed in claim 2, wherein one end of the damping extension element is pivotally connected with an upper section of the second frame, the other end of the damping extension element is pivotally connected with the first lower cross rod.

5. The lifting platform as claimed in claim 2, wherein the damping extension element is a pneumatic cylinder with locking function, which is used to provide pushing force for extension when it is unlocked.

6. The lifting platform as claimed in claim 2, wherein a stopper element adjustable for position is set on the bearing platform, the stopper element is located on moving path of at least one of the first and the second upper cross rod, the stopper element is provided to adjust for limiting slidable range of the first or the second upper cross rod, to thereby limit the angle between the first and the second frames, so that the bearing platform is limited and stopped at a predetermined lifting height.

7. The lifting platform as claimed in claim 6, wherein the stopper element includes a protruding stopper portion and at least a long hole, the stopper portion is provided to stop the first or the second upper cross rod, the at least a long hole is provided for a positioning element to pass through and screw into the bottom side of the bearing platform, so that the stopper element is adjustably fixed to a predetermined position on the bottom side of the bearing platform.

8. The lifting platform as claimed in claim 1, wherein the damping extension element is a pneumatic cylinder with locking function, which is used to provide pushing force for extension when it is unlocked.

9. The lifting platform as claimed in claim 8, wherein the control switch is connected to the damping extension element through a control cord.

10. The lifting platform as claimed in claim 8, wherein an adjustment element is set on one end of the damping extension element, the adjustment element is provided to change position of the end of the damping extension element for adjusting a setting angle of the damping extension element, to thereby adjust the pushing force for supporting formed by the damping extension when it is unlocked.

11. The lifting platform as claimed in claim 10, wherein the adjustment element includes a rotatable threaded rod and a slider screwed on the rotatable threaded rod, and the end of the damping extension element is pivotally combined with the slider, the position of the slider is adjusted when the rotatable threaded rod rotates, so that the setting angle of the damping extension element is adjusted.

12. The lifting platform as claimed in claim 10, wherein there are a plurality of positioning connecting rods defined as an upper positioning connecting rod or a lower positioning connecting rod respectively, each of the upper positioning connecting rod is set between an upper section of the first frame or the second frame and the bearing platform, each of the lower positioning connecting rod is set between a lower section of the first frame or the second frame and the base.

13. The lifting platform as claimed in claim 10, wherein one end of the damping extension element is pivotally connected with the first frame or the second frame, and the other end of the damping extension element is pivotally set on the bearing platform or the base.

14. The lifting platform as claimed in claim 10, wherein two ends of the damping extension element are pivotally connected with the first frame and the second frame respectively, one of the ends is set on an upper section of one of the first and the second frames, and the other of the ends is set on a lower section of another of the first and the second frames.

15. The lifting platform as claimed in claim 11, wherein the base includes several lower guide grooves parallel and symmetrical to each on two sides of the two ends of the base; the bearing platform includes several slide seats parallel and symmetrical to each other on two sides of the two ends of the bottom side of the bearing platform, each of the slide seat includes an upper guide groove extendedly parallel to each other on relative side; a first upper cross rod is set on an upper end of the first frame, two ends of the first upper cross rod are respectively inserted into the upper guide grooves of the two slide seats on a side of the bearing platform, a first lower cross rod is set on a lower end of the first frame, two ends of the first lower cross rod are respectively inserted into two lower guide grooves on a side of the base, a second upper cross rod is set on an upper end of the second frame, two ends of the second upper cross rod are respectively inserted into the upper guide grooves of two slide seats on the other side of the bearing platform, a second lower cross rod is set on a lower end of the second frame, two ends of the second lower cross rod are respectively inserted into the lower guide grooves on the other side of the base respectively.

16. The lifting platform as claimed in claim 15, wherein the adjustment element is set on a lower section of the second frame, one end of the damping extension element is pivotally connected with the first upper cross rod, the other end of the damping extension element is pivotally combined with the slider of the adjustment element.

17. The lifting platform as claimed in claim 15, wherein the adjustment element is set on an upper section of the second frame, one end of the damping extension element is pivotally connected with the first lower cross rod, the other end of the damping extension element is pivotally combined with the slider of the adjustment element.

18. The lifting platform as claimed in claim 15, wherein a stopper element adjustable for position is set on the bearing platform, the stopper element is located on moving path of at least one of the first and the second upper cross rods, the stopper element is provided to adjust for limiting slidable range of the first or the second upper cross rod, to thereby limit the angle between the first and the second frames, so that the bearing platform is limited and stopped at a predetermined lifting height.

19. The lifting platform as claimed in claim 18, wherein the stopper element includes a protruding stopper portion and at least a long hole, the stopper portion is provided to stop the first or the second upper cross rod, the at least a long hole is provided for a positioning element to pass through and screw into the bottom side of the bearing platform, so that the stopper element is adjustably fixed to a predetermined position on the bottom side of the bearing platform.
